(19) United States
(12) Patent Application Publication
(10) Pub. No.: US 2013/0276892 A1
(43) Pub. Date: Oct. 24, 2013

(54) PNEUMATIC BUTTERFLY VALVE

(71) Applicants: Josh Kamp, Glastonbury, CT (US); Jay Stradinger, Enfield, CT (US); Bruce R. Schroder, Agawam, MA (US); Peter J. Dowd, Granby, CT (US)

(72) Inventors: Josh Kamp, Glastonbury, CT (US); Jay Stradinger, Enfield, CT (US); Bruce R. Schroder, Agawam, MA (US); Peter J. Dowd, Granby, CT (US)

(73) Assignee: Hamilton Sundstrand Corporation, Windsor Locks, CT (US)

(21) Appl. No.: 13/453,712

(22) Filed: Apr. 23, 2012

(51) Int. Cl. F16K 1/22; F16K 31/00

(52) U.S. Cl. 137/1; 251/305; 251/64

(57) ABSTRACT

A butterfly valve includes a duct defining a flow pathway and a valve disc rotably disposed in the flow pathway. A pneumatic actuator includes an intermediate chamber housing an actuator piston and is operably connected to the valve disc to drive rotation of the valve disc. A downstream bleed conduit extends from the flow pathway downstream of the valve disc to the intermediate chamber to pressurize the intermediate chamber thereby reducing a rate of movement of the valve disc in the flow pathway.

### BACKGROUND OF THE INVENTION

The subject matter disclosed herein relates to valves. More specifically, the subject matter disclosed herein relates to control of butterfly valve positioning.

A typical butterfly valve is controlled by a pneumatic actuator. The actuator includes a piston positioned in a cylinder. The piston is connected to a linkage that converts linear motion of the piston in the cylinder to rotary motion of the linkage. The linkage is, in turn connected to a butterfly disc located in a duct, or other flow structure. Rotation of the linkage rotates the butterfly disc in the duct, thus opening or closing the valve.

In a typical cylinder of a butterfly valve, the cylinder has an upstream cavity connected to a pneumatic supply and a downstream cavity also connected to the pneumatic supply. A controller directs the pneumatic supply to increase or decrease the pressure in the downstream cavity to drive motion of the piston in the cylinder to either open or close the valve, as the upstream cavity is maintained at a constant pressure. The typical arrangement also includes an intermediate cavity located between a downstream piston face and an upstream piston face, which is vented directly to ambient. The controller attempts to modulate the piston position by controlling the pressure in the downstream cavity. As the piston approaches a selected position, the controller adjusts the downstream cavity pressure to balance the upstream cavity pressure, thus stopping the piston from further movement. Unfortunately, balancing the two cavity pressures at the exact time the piston is in the selected position has proven to be difficult. The piston often overshoots the selected position, thus resulting in valve instability.

### BRIEF DESCRIPTION OF THE INVENTION

In one embodiment, a butterfly valve includes a duct defining a flow pathway and a valve disc rotably disposed in the flow pathway. A pneumatic actuator includes an intermediate chamber housing an actuator piston and is operably connected to the valve disc to drive rotation of the valve disc. A downstream bleed conduit extends from the flow pathway downstream of the valve disc to the intermediate chamber to pressurize the intermediate chamber thereby reducing a rate of movement of the valve disc in the flow pathway.

In another embodiment, a method of operating a butterfly valve includes pressurizing a pneumatic actuator by flowing air from a pneumatic source and translating a piston of the pneumatic actuator via the pressurization. A valve disc operably connected to the piston and located in a flow pathway is rotated by the translation of the piston. A flow of air is bled from the flow pathway downstream of the valve disc to an intermediate chamber of the pneumatic actuator, and the intermediate chamber is pressurized via the flow of air from the flow pathway to reduce a rate of movement of the valve disc in the flow pathway.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawing in which:

FIG. 1 is a schematic of an embodiment of a pneumatic butterfly valve system; and

FIG. 2 is a schematic of a vent portion of an embodiment of a pneumatic butterfly valve system.

The detailed description explains embodiments of the invention, together with advantages and features, by way of example with reference to the drawing.

### DETAILED DESCRIPTION OF THE INVENTION

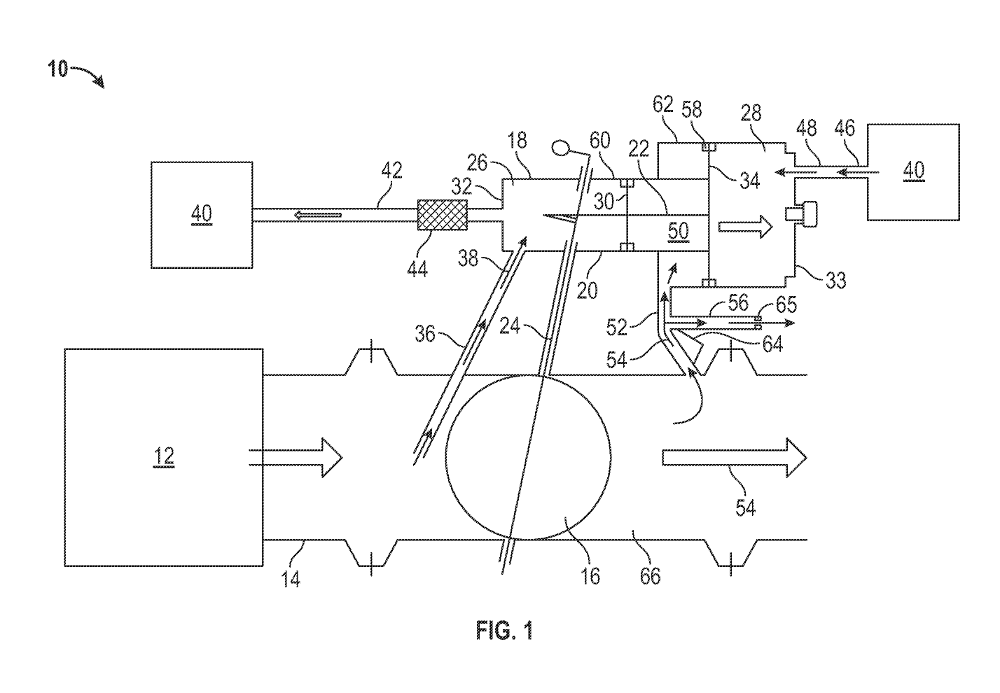

Shown in FIG. 1 is an embodiment of a pneumatically-operated butterfly valve 10, such as those utilized to regulate bleed airflow from, for example, a compressor 12. A bleed duct 14 extends from the compressor 12 to a valve duct 66, and a valve disc 16 is rotably positioned in the valve duct 66 such that rotation of the valve disc 16 decreases or increases flow allowable through the valve duct 66 and the bleed duct 14. The valve disc 16 is connected to a pneumatic actuator 18, which drives rotation of the valve disc 16. The actuator 18 includes a cylinder 20 with a piston 22 slidably positioned in the cylinder 20. The piston 22 is connected to the valve disc 16 via one or more linkages 24 to translate sliding motion of the piston 22 in the cylinder 20 into rotary motion of the valve disc 16.

Movement of the piston 22 in the cylinder 20 is determined by a difference in pressure between an upstream chamber 26 of upstream cylinder 60 and a downstream chamber 28 of downstream cylinder 62. The upstream chamber 26 is defined by an upstream face 30 of the piston 22 and an inner wall 32 of the upstream cylinder 60, while the downstream chamber 28 is defined by a downstream face 34 of the piston 22 and an inner wall 33 of the downstream cylinder 62. Downstream cylinder 62 has a different diameter, in this embodiment, a larger diameter, than upstream cylinder 60. The pressure in the upstream chamber 26 is maintained as a substantially constant pressure. To do so, an upstream tap 36 extends from the valve duct 66 into the upstream chamber 26 to supply an upstream airflow 38, as needed, to the upstream chamber 26. Upstream airflow 38 is also routed to a controller 40 via return conduit 42. In some embodiments, the return conduit 42 includes a filter 44 to filter the upstream airflow 38 so that the controller 40 is not contaminated. In some embodiments, the controller 40 is an electronically-controlled pneumatic device. The pressure in the downstream chamber 28 is controlled via a downstream pneumatic inlet 46 connected to the controller 40. Increasing an inlet flow 48 via the downstream pneumatic inlet 46 increases the pressure in the downstream chamber 28. Pressure balance is achieved by maintaining a ratio of an upstream pressure in the upstream chamber 26 and a downstream pressure in the downstream chamber 28 equal to a ratio of the areas of the upstream cylinder 60 and the downstream cylinder 62. The pressures in the upstream chamber 26 and the downstream chamber 28 when pressure balance is achieved may be referred to as “upstream balance pressure” and “downstream balance pressure”, respectively. When the pressure in the downstream chamber 28 is greater than the downstream balance pressure, the piston 22 is urged toward the return conduit 42. The movement of the piston 22 moves the linkage 24 to rotate the valve disc 16 toward a fully opened position. Decreasing the pressure in the downstream chamber 28 such that the pressure in the upstream chamber 26 is greater than the upstream balance pressure urges the piston 22 toward the downstream pneumatic inlet 46, which results in the movement of the valve disc 16 toward a fully closed position.

The valve 10 disclosed herein includes a dampening mechanism to control the motion of the valve disc 16 between the fully opened position and the fully closed position to slow or stop the movement of the valve disc 16. The piston 22 includes an intermediate chamber 50 located between the upstream face 30 and the downstream face 34 of the piston 22. A downstream bleed conduit 52 extends from the bleed duct 14 at a location downstream of the valve disc 16, to the intermediate chamber 50. Duct flow 54 downstream of the valve disc 16, flows from the valve duct 66 through the downstream bleed conduit 52 to pressurize the intermediate chamber 50. In some embodiments, as shown in FIG. 1, the downstream bleed conduit 52 extends away from the valve duct 66 at an angle greater than 90 degrees relative to the duct flow 54 direction, to prevent ingestion of contaminants into the downstream bleed conduit 52. The pressurization of the intermediate chamber 50 can slow or stop movement of the piston 22 during operation of the valve 10, thus making the valve motion more controllable and precise. For example, the valve disc 16 may be set in a half-open position or other selected position between fully opened and fully closed.

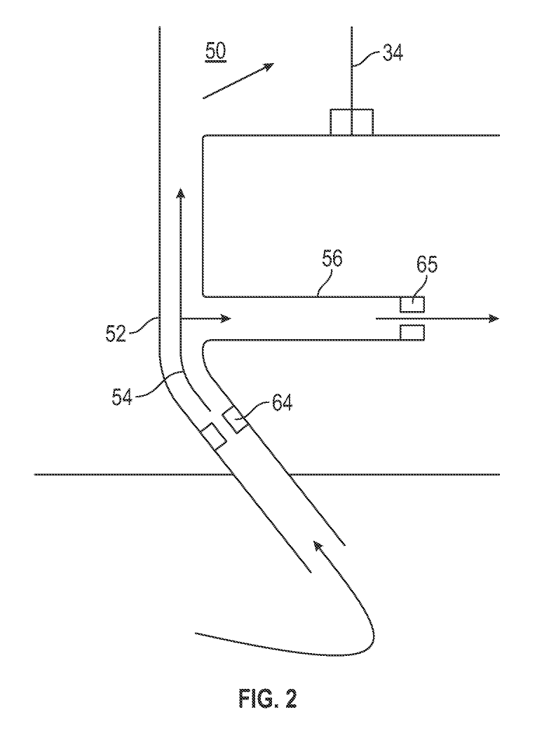

Referring now to FIG. 2, to control the amount of pressurization of the intermediate chamber 50, a downstream vent conduit 56 extends from the downstream bleed conduit 52 and vents to ambient through a restriction 65. The downstream bleed conduit 52 and the downstream vent conduit 56 are sized and configured to pressurize the intermediate chamber 50 to a selected pressure, for example, between about 70% and 95% of a downstream duct pressure, which is a pressure in the valve duct 66 downstream of the valve disc 16. This degree of pressurization effectively slows the movement of the piston 22 and valve disc 16 to a selected rate of rotation, thereby making the operation of the valve more controllable. In other embodiments, the selected pressure of the intermediate chamber 50 is about 80% of the downstream duct pressure. In some embodiments, the downstream bleed conduit 52 includes a restriction 64, such as a narrowing, at a location along its length, for example, at the valve duct 66. Similarly, the downstream vent conduit 56 may include a restriction 64 at the downstream bleed conduit. The restrictions are provided to prevent pressure in the intermediate chamber 50 from equaling the downstream duct pressure. While the selected pressure is within the range above in some embodiments, it is to be appreciated that in other embodiments the selected pressure may be between the downstream duct pressure and ambient pressure, as determined by the relative restrictions in the downstream bleed conduit 52 and the downstream vent conduit 56. Further, utilization of the downstream vent conduit 56 prevents a detrimental temperature increase in the intermediate chamber 50 which would result in deterioration of piston ring seals 58 located at the piston 22 to seal between the piston 22 and cylinder 20.

In some embodiments, the upstream tap 36, the downstream bleed conduit 52 and/or the downstream vent conduit 56 are formed integral to the valve 10 by, for example, casting. Alternatively, the upstream tap 36, the downstream bleed conduit 52 and/or the downstream vent conduit 56 are formed separately and joined to the valve 10 by welding, brazing, adhesives, or mechanical fasteners.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

1. A butterfly valve comprising:
a duct defining a flow pathway;
a valve disc rotably disposed in the flow pathway;
a pneumatic actuator including an intermediate chamber housing an actuator piston, the pneumatic actuator operably connected to the valve disc to drive rotation of the valve disc; and
a downstream bleed conduit extending from the flow pathway downstream of the valve disc to the intermediate chamber to pressurize the intermediate chamber thereby reducing a rate of movement of the valve disc in the flow pathway.

2. The butterfly valve of claim 1, further comprising a downstream vent conduit extending from the downstream bleed conduit to prevent over pressurization of the intermediate chamber.

3. The butterfly valve of claim 2, wherein the downstream vent conduit extends to ambient.

4. The butterfly valve of claim 1, wherein the downstream bleed conduit extends from the flow pathway at an angle greater than ninety degrees relative to a flow direction through the flow pathway.

5. The butterfly valve of claim 4, wherein the angle of the downstream bleed conduit prevents ingestion of contaminants into the downstream bleed conduit.

6. The butterfly valve of claim 1, wherein the downstream bleed conduit is configured to pressurize the intermediate chamber to between about 70% and about 95% of a flow pathway pressure downstream of the valve disc.

7. The butterfly valve of claim 6, wherein the downstream bleed conduit is configured to pressurize the intermediate chamber to about 80% of the flow pathway pressure downstream of the valve disc.

8. The butterfly valve of claim 1, wherein the downstream bleed conduit includes a restriction therein to control an intermediate chamber pressure relative to a duct pressure.

9. The butterfly valve of claim 1, wherein the intermediate chamber is disposed in the pneumatic actuator between a downstream face of the actuator piston and an upstream face of the actuator piston.

10. The butterfly valve of claim 1, wherein the downstream bleed conduit is formed integral with the duct.

11. A method of operating a butterfly valve comprising:
pressurizing a pneumatic actuator by flowing air from a pneumatic source;
translating a piston of the pneumatic actuator via the pressurization;
rotating a valve disc operably connected to the piston and disposed in a flow pathway by the translation of the piston;
bleeding a flow of air from the flow pathway downstream of the valve disc to an intermediate chamber of the pneumatic actuator; and
pressurizing the intermediate chamber via the flow of air from the flow pathway to reduce a rate of movement of the valve disc in the flow pathway.

12. The method of claim 11, wherein the bleeding of air from the flow pathway is accomplished via a downstream bleed conduit extending from the flow pathway to the intermediate chamber.

13. The method of claim 12, further comprising venting a portion of the air from the downstream bleed conduit to prevent over pressurization of the intermediate chamber.

14. The method of claim 13, further comprising venting the portion of the air from the downstream bleed conduit to ambient.

15. The method of claim 9, further comprising bleeding the air from the flow pathway in a direction at a greater than ninety degree angle relative to a flow direction through the fluid pathway.

16. The method of claim 11, further comprising pressurizing the intermediate chamber to between about 70% and about 95% of a flow pathway pressure downstream of the valve disc.

17. The method of claim 16, further comprising pressurizing the intermediate chamber to about 80% of the flow pathway pressure downstream of the valve disc
